(19) United States
(12) Patent Application Publication
(10) Pub. No.: US 2024/0174210 A1
(43) Pub. Date: May 30, 2024

(54) BRAKE SYSTEM AND METHOD FOR OPERATING SAME

(71) Applicant: Continental Automotive Technologies GmbH, Hannover (DE)

(72) Inventors: Marc Lenz, Neu-Anspach (DE); Holger Kollmann, Rodgau (DE); Christian Courth, Frankfurt (DE)

(73) Assignee: Continental Automotive Technologies GmbH, Hannover (DE)

(21) Appl. No.: 18/577,591

(22) PCT Filed: Jun. 23, 2022
(86) PCT No.: PCT/DE2022/200139

§ 371 Date: Jan. 8, 2024

(30) Foreign Application Priority Data
Jul. 8, 2021 (DE) 10 2021 207 219.4

(51) Int. Cl. B60T 13/68

(52) U.S. Cl. CPC B60T 13/686; B60T 2270/413

(57) ABSTRACT

A brake system for a motor vehicle includes hydraulic output ports for activatable wheel brakes. The system includes an electrically actuatable hydraulic pressure source The system also includes a pressure medium reservoir under atmospheric pressure. An electrically activatable inlet valve is connected between each output port and the pressure source. An electrically activatable outlet valve is connected between each outlet port and the pressure medium reservoir Each of the inlet valves is embodied as a 2/2-way valve and in such a manner that the inlet valve can be closed in relation to pressure differences from both directions and can be opened in relation to pressure differences from both directions.

### CROSS-REFERENCE TO RELATED APPLICATIONS

This application is a national stage application, filed under 35 U.S.C. § 371, of international patent application No. PCT/DE2022/200139, filed on Jun. 6, 2022, which claims priority to German patent application No. 10 2021 207 219.4, filed on Jul. 8, 2021, each of which is incorporated by reference.

### TECHNICAL FIELD

The technical field relates to a brake system and a method for operating a brake system.

### BACKGROUND

A brake system for four hydraulically activatable wheel brakes is known from DE 10 2017 219 598 A1, having a brake pedal-activatable master brake cylinder as a hydraulic fallback plane and an electrically actuatable hydraulic pressure source. The electrically actuatable pressure source is separably connected to a brake supply line by way of a sequence valve which is closed when non-energized, the inlet valves of the wheel brakes being connected to said brake supply line. A check valve is connected in parallel to each inlet valve, so that pressure medium can flow from the wheel brake in the direction of the pressure source or the brake circuit supply line even when the inlet valve is closed.

Known from DE 10 2017 216 617 A1 is a brake control unit having four output ports for four hydraulically activatable wheel brakes, a first electronic control and feedback-control unit, a second electronic control and feedback-control unit, a pressure medium reservoir, and one electrically activatable inlet and outlet valve per output port. In order to be suitable for highly automated driving and to be able to dispense with a mechanical and/or hydraulic fallback plane in which the driver can actuate the wheel brakes by muscle force, the brake control unit comprises a first and a second electrically actuatable hydraulic pressure source, which are designed as linear actuators, wherein the first pressure source is activated by the first electronic control and feedback-control unit and the second pressure source is activated by the second electronic control and feedback-control unit, as well as a plurality of other electrically activatable valves. Each of the two electrically activatable linear actuators is separably connected to a brake supply line by way of a sequence valve which is open when non-energized, the inlet valves of the wheel brakes being connected to said brake supply line. The sequence valves, which are open when non-energized, ensure that the wheel brakes are connected to the pressure medium reservoir in the non-energized state of the brake system, and are thus switched so as not to be pressurized. In order to enable pressure medium to be suctioned into the linear actuator, the associated sequence valve must be actuated and closed. Also in this brake system, each inlet valve is connected in parallel with a check valve, so that in the event of a negative pressure difference over an inlet valve (ΔP=Psystem−Prad), i.e. if the brake pressure (Prad) at the inlet valve outlet port on the wheel brake side is greater than the brake pressure (Psystem) at the inlet valve inlet port on the pressure source side, pressure medium flows from the wheel brake in the direction of the pressure source, or the brake circuit supply line, respectively, even with the inlet valve closed. The brake control unit is complex to manufacture and costly. In order to ensure adequate availability of the brake control unit, the entirety of electrically activatable valves in terms of their actuation and/or activation is furthermore distributed between the two electronic control and feedback-control units, i.e. each of the two electronic control and feedback-control units must actuate valves. This is likewise disadvantageous.

There is an opportunity to present an alternative brake system for a motor vehicle, which is suitable for highly automated driving, and a method for its operation, which can dispense with a mechanical and/or hydraulic fallback plane and yet still has a high availability and thus offers sufficient reliability for highly automated driving, or an autopilot function, respectively.

### SUMMARY

A brake system includes an electrically actuatable hydraulic pressure source for at least four hydraulically activatable wheel brakes, which is formed by a cylinder-piston assembly having a pressure chamber and a piston, wherein the piston is able to be pushed forward and backward by an electric motor, a first electronic control and feedback-control unit, a second electronic control and feedback-control unit, a pressure medium reservoir, one electrically activatable inlet valve per output port or wheel brake, respectively, which is open when non-energized, and one electrically activatable outlet valve per output port or wheel brake, respectively, which is closed when non-energized, wherein the electric motor of the pressure source is able to be actuated by the first and second electronic control and feedback-control units, and wherein each of the inlet valves is embodied as a 2/2-way valve and in such a manner that the inlet valve can be closed in relation to pressure differences from both directions by actuating its solenoid coil, and can be opened in relation to pressure differences from both directions by switching off or reducing the actuation of its solenoid coil.

The hydraulic connection between the pressure source and the output ports is thus configured in such a manner that, for positive pressure differences as well as for negative pressure differences over the inlet valves, the hydraulic connection between the pressure source and the output ports can be closed, or kept closed, by actuating the solenoid coils of the inlet valves, and can be opened by switching off or reducing the actuation of the solenoid coils of the inlet valves.

Since the electric motor of the pressure source, or its activation, is designed with redundancy, the brake system according to the invention offers the advantage that, in the event of failure of one of the electronic control and feedback-control units, the electric motor of the pressure source can be actuated by the other electronic control and feedback-control unit in order to provide a brake pressure for carrying out service braking. Moreover, the brake system according to the invention offers the advantage that a sequence valve between the pressure source and inlet valves can be dispensed with, since the inlet valves can be used for reliable hydraulic separation of the pressure chamber of the pressure source from the wheel brakes during a feeding procedure of the pressure source.

The inlet valves are embodied in such a manner that they can be closed, or can be kept closed, in relation to a positive pressure difference, or else in relation to a negative pressure difference, over the inlet valve by activating their solenoid coils, wherein a negative pressure difference over the inlet valve is referred to if the brake pressure at the inlet valve output port on the wheel brake side is greater than the brake pressure at the inlet valve input port on the pressure source side. This functionality of holding or locking a higher pressure at the wheel brakes, e.g. when the pressure in the pressure source is lowered during a feeding procedure, is not guaranteed in the known brake system of DE 10 2017 219 598 A1 or DE 10 2017 216 617 A1, owing to the check valves being connected in parallel, or integrated, respectively.

In one embodiment, none of the inlet valves is connected in parallel with a check valve. In one embodiment, none of the inlet valves comprises an integrated check valve.

Furthermore, the inlet valves are embodied in such a manner that they can be opened in relation to a positive as well as in relation to a negative pressure difference over the corresponding inlet valve by deactivating the corresponding solenoid coil.

In one embodiment, the compression spring of each inlet valve is dimensioned such that the inlet valve can be opened in relation to a negative pressure difference over the inlet valve by switching off the actuation of its solenoid coil.

Each of the inlet valves may be (kept) closed and can be opened in relation to a pressure difference (from both directions) of up to 120 bar. This applies to positive and negative pressure differences up to a value of 120 bar. Each of the inlet valves may be opened in relation to a negative pressure difference up to 100 bar by the compression spring. For positive pressure differences, the ability to keep the valve closed in relation to up to 120 bar by way of magnetic force is advantageous.

According to a one embodiment of the brake system, the pressure source and the electronic control and feedback-control units are configured in such a manner that, in the event of failure of the first electronic control and feedback-control unit, the pressure source is actuated by the second electronic control and feedback-control unit and builds up pressure for activating the wheel brakes and that, in the event of failure of the second electronic control and feedback-control unit, the pressure source is actuated by the first electronic control and feedback-control unit and builds up pressure for activating the wheel brakes.

According to one embodiment of the brake system, the pressure source includes a double-wound electric motor having a first motor winding and a second motor winding, wherein the first motor winding is actuated by, particularly exclusively by, the first electronic control and feedback-control unit, and the second motor winding is actuated by, particularly exclusively by, the second electronic control and feedback-control unit. A second electrically actuatable hydraulic pressure source can thus be dispensed with. Even after an individual electrical or electronic fault, it is possible to brake the wheel brakes. The double-wound electric motor thus comprises a first motor winding and a second motor winding, wherein each of the two motor windings is in each case actuated by one of the two electronic control and feedback-control units. In a certain sense, the electric motor is embodied in two parts. If both motor windings are actuated by both electronic control and feedback-control units, the electric motor delivers its full output. In the event that only one of the two electronic control and feedback-control units actuates the corresponding motor winding, the pressure source can build up pressure, even if at reduced level and with reduced dynamics, the wheel brakes being impinged with this pressure. The vehicle can nevertheless be decelerated and brought to a standstill.

In order to achieve a brake system which is as compact as possible and to reduce the number of electrically actuatable valves, the pressure chamber of the pressure source is preferably hydraulically connected to each of the inlet valves without the interconnection of an electrically activatable valve.

In one embodiment, no electrically activatable valve, particularly no valve, is disposed between the pressure chamber of the pressure source and each of the inlet valves.

Apart from the inlet and outlet valves, the brake system preferably does not include any other electrically activatable valves.

In one embodiment, the pressure chamber is connected to the pressure medium reservoir in a non-activated state of the pressure source, or of the piston of the pressure source. Thus, a pressure equalization function is implemented in such a manner that the pressure source is moved to the non-activated state in order to release a hydraulic pressure equalization connection from the pressure source or the pressure chamber to the pressure medium reservoir. In this way, the wheel brakes can be connected to the pressure medium reservoir, which is under atmospheric pressure, by way of the pressure source, or the pressure chamber, and the prevailing brake pressure can be reduced. Particularly, the pressure chamber is hydraulically separated from the pressure medium reservoir when the pressure source or the piston is activated.

For pressure equalization with the pressure medium reservoir, the pressure chamber of the pressure source may be hydraulically connected to the pressure medium reservoir by way of a breather hole when the pressure source (or the piston of the pressure source) is in a non-activated state. Particularly, the breather hole is closed during activation of the pressure source, or of the piston of the pressure source, respectively, so that the connection to the pressure medium reservoir is separated.

For feeding pressure medium into the pressure chamber of the pressure source, the pressure chamber may be hydraulically connected to the pressure medium reservoir by way of a check valve opening in the direction of the pressure chamber, irrespective of the activation state of the pressure source.

According to one embodiment of the brake system, the electrically activatable inlet and outlet valves are activated by the first electronic control and feedback-control unit.

In one embodiment, each electrically actuatable valve of the brake system is activated by the first electronic control and feedback-control unit.

In one embodiment, the inlet and outlet valves, in particular each electrically actuatable valve of the brake system, is activated exclusively by one of the electronic control and feedback-control units, particularly preferably the first electronic control and feedback-control unit.

In one embodiment, the brake system includes a pressure sensor by means of which the pressure generated by the pressure source is determined. Additional pressure sensors, e.g., for determining a wheel brake pressure, are not necessary. In one embodiment, the pressure sensor determines a pressure at the pressure source side of the inlet valves.

In one embodiment, the signals of the pressure sensor are supplied to the first electronic control and feedback-control unit and evaluated by the latter. The pressure value of the pressure source is thus available to the (first) electronic control and feedback-control unit, which also controls the inlet and outlet valves for controlling the wheel brake pressures.

According to a refinement, the brake system comprises redundant elements for detecting a rotating speed or rotation angle of the electric motor, wherein the signals of one of the redundant elements are supplied to the one electronic control and feedback-control unit and evaluated by the latter, and the signals of the other redundant element are supplied to the other electronic control and feedback-control unit and evaluated by the latter.

In one embodiment, the brake system comprises a first sensor for detecting a rotation angle or a rotating speed of the electric motor, and an independent second sensor for detecting a rotation angle or a rotating speed of the electric motor, wherein the signals of the first sensor are supplied to the second electronic control and feedback-control unit and evaluated by the latter, and the signals of the second sensor are supplied to the first electronic control and feedback-control unit and evaluated by the latter.

The brake system in one embodiment does not comprise any other electrically actuatable hydraulic pressure source.

The brake system in one embodiment does not include any other hydraulic pressure source. The brake system does not include, for example, a hydraulic pressure source that is able to be activated by the brake pedal, in particular no master brake cylinder that is able to be activated by a brake pedal and is able to be connected to the wheel brakes.

The brake system may be supplied by a first electrical power supply and by a second electrical power supply, which is independent of the first power supply.

In one embodiment, the first electronic control and feedback-control unit is supplied by a first electrical power supply and the second electronic control and feedback-control unit is supplied by a second electrical power supply, which is independent of the first power supply.

The first electronic control and feedback-control unit and the second electronic control and feedback-control unit may be electrically independent of one another in the sense that a failure of the first electronic control and feedback-control unit does not cause a failure of the second electronic control and feedback-control unit, and vice versa.

In one embodiment, the inlet and outlet valves are embodied as 2/2-way valves. The inlet and outlet valves may be designed as switchover valves.

In one embodiment, the electrically actuatable hydraulic pressure source and the inlet and outlet valves are disposed in a single hydraulic valve block.

In one embodiment, the electrically actuatable hydraulic pressure source, the inlet and outlet valves and the electronic control and feedback-control units are disposed in a single brake control unit. The brake control unit furthermore particularly preferably comprises the pressure sensor, the check valve, and the first and second sensor for detecting a rotation angle or a rotating speed of the electric motor.

According to a one refinement of the brake system, the latter includes an activation unit for a driver of a vehicle, wherein the activation unit is connected to at least one of the electronic control and feedback-control units for transmitting a signal of the driver's intention. Here, there is no mechanical-hydraulic connection between the activation unit and the hydraulically activatable wheel brakes (e.g. no hydraulic fallback plane).

In one embodiment, the brake system includes a first electrically activatable parking brake and a second electrically activatable parking brake, which are assigned to a vehicle axle, in particular the rear axle, of the motor vehicle. The first electrically activatable parking brake may be activated by the first electronic control and feedback-control unit, and the second electrically activatable parking brake may be activated by the second electronic control and feedback-control unit. A redundant parking brake function is achieved in this way.

The invention also relates to a method for operating a brake system.

In one embodiment, the inlet valves are closed for feeding pressure media into the pressure chamber of the pressure source, so that the pressure in the wheel brakes is maintained, and the piston of the pressure source is retracted by the electric motor. Due to the design embodiment according to the invention of the brake system and the inlet valves, the pressure in the wheel brakes can be maintained.

In one embodiment, the piston of the pressure source is subsequently advanced by the electric motor, with the inlet valves closed, until the (system brake) pressure of the pressure source is approximated to the pressures of the wheel brakes, and the inlet valves are opened.

For monitoring the brake system, in particular for detecting an incorrectly closed inlet valve, a comparison of a model pressure medium volume, determined by way of a measured (system brake) pressure of the pressure source, and a pressure medium volume displaced by the pressure source may be carried out. In the event of a significant or persistent variation of the compared volume values, it can be concluded that one or a plurality of inlet valves is/are unintentionally closed. The outlet valves are opened in order for the wheel brakes to be reliably released.

In one embodiment, an axle-specific or wheel-specific pressure feedback-control is carried out with a first target pressure value and a lower second target pressure value in that, by means of the pressure source in the wheel brakes, the first target pressure value is set, the inlet valve(s) of the wheel brake(s), which is/are to be activated with this first target pressure value, are closed, and a pressure adjustment to the second target pressure value is carried out on the other wheel brake(s) by moving the piston of the pressure source.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows an exemplary embodiment of a brake system;

FIG. 2 shows an exemplary method for feeding pressure media into the pressure source;

FIG. 3 shows an exemplary method for identifying a fault on an inlet valve; and

FIG. 4 shows an exemplary method for the axle-specific pressure feedback-control.

### DETAILED DESCRIPTION

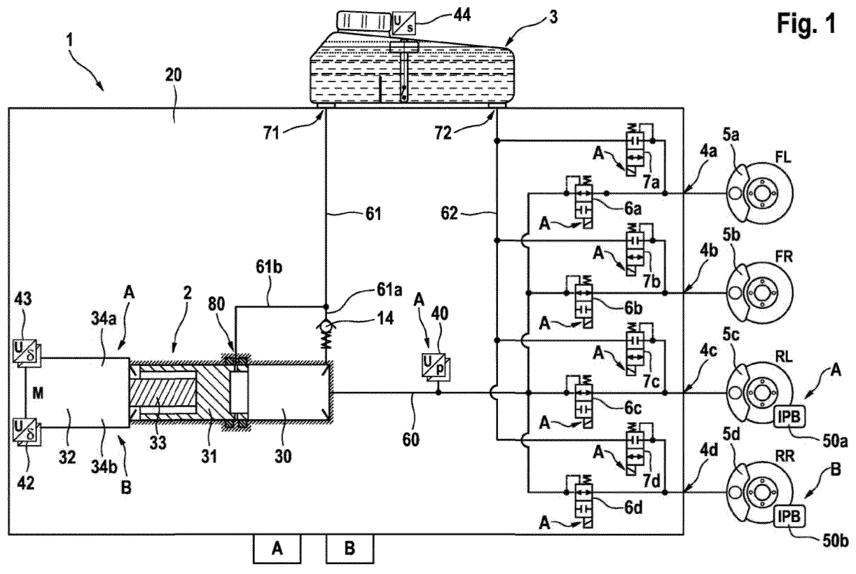

An exemplary embodiment of a brake system 1 for a motor vehicle, having four hydraulically activatable wheel brakes 5a-5d, is schematically illustrated in FIG. 1.

The brake system 1 advantageously comprises a brake control unit (HECU) having a hydraulic block 20 (hydraulic control and feedback-control unit HCU, valve block) with an output port 4a-4d for each of the wheel brakes 5a-5d. A pressure medium reservoir 3 which is under atmospheric pressure is arranged on the valve block. According to the example, the output ports 4a, 4b are assigned to the wheel brakes 5a, 5b of the front axle (front), e.g. the output port 4a to the left front wheel FL (wheel brake 5a) and the output port 4b to the right front wheel FR (wheel brake 5b), and the output ports 4c, 4d are assigned to the wheel brakes 5c, 5d of the rear axle (rear), e.g. the output port 4c to the left rear wheel RL (wheel brake 5c) and the output port 4d to the right rear wheel RR (wheel brake 5d).

The fill level of the pressure medium reservoir 3 is measured by a fill level sensor 44.

Each output port 4a-4d is assigned an inlet valve 6a-6d and an outlet valve 7a-7d, wherein the inlet valves 6a-6d are open when non-energized, and the outlet valves 7a-7d are closed when non-energized. In one embodiment, the inlet valves 6a-6d and the outlet valves 7a-7d are embodied as 2/2-way valves. Particularly, the inlet valves 6a-6d and the outlet valves 7a-7d may be embodied as 2/2-switchover valves.

The respective output port 4a-4d is connected to the pressure medium reservoir 3 by way of the outlet valve 7a-7d. According to the example, the outlet valves 7a-7d are connected by way of a common return line 62 to a port 72 of the pressure medium reservoir 3.

An electrically actuatable hydraulic pressure source 2 is provided, which is formed by a cylinder-piston assembly having a pressure chamber 30, the piston 31 of which is activatable by an electromechanical actuator with a schematically indicated electric motor 32 and a schematically illustrated rotational-to-translational gearbox 33. According to the example, the pressure source 2 is configured as a single-circuit electro-hydraulic linear actuator (LAC) with only one pressure chamber 30. The piston 31 can be advanced by electromechanical actuator to build up pressure (brake actuation direction) and pushed back or retracted to reduce pressure.

According to the example, the electric motor is configured as a double-wound electric motor 32 having a first motor winding 34a and a second motor winding 34b. If both motor windings 34a, 34b are actuated, the electric motor 32 delivers its full output. If only one of the two motor windings 34a, 34b is actuated, then, although the power of the electric motor 32 is reduced, pressure can still be built up by the pressure source 2, albeit at a reduced level and with reduced dynamics.

The pressure chamber 30 is hydraulically connected to a brake line portion 60, which is hydraulically connected to the inlet valves 6a-6d (more specifically, the inlet ports of the inlet valves 6a-6d). Advantageously, no electrically activatable valve is disposed in the hydraulic connection between the pressure chamber 30 of the pressure source 2 and each of the inlet valves 6a-6d. According to the example, no valve, nor a check valve, is disposed in the hydraulic connection between the pressure chamber 30 and each of the inlet valves 6a-6d. In this sense, the pressure chamber 30 is hydraulically connected directly to the inlet valves 6a-6d. This offers the advantage of low throttle losses in the main flow path from the pressure source 2 to the inlet valves 6a-6d and the wheel brakes 5a-5d.

The inlet valves 6a-6d are embodied as 2/2-way valves with a compression spring and a solenoid coil for closing/opening the valve tappet. Each inlet valve 6a-6d is embodied in such a manner that it can be closed or kept closed in relation to a positive as well as in relation to a negative pressure difference over the inlet valve, i.e. in relation to pressure differences from both directions, by a corresponding actuation of its solenoid coil. A negative pressure difference ΔP (ΔP=Psystem−Prad) over the inlet valve is referred to when the (wheel) brake pressure Prad at the inlet valve outlet port on the wheel brake side is greater than the (system) brake pressure Psystem at the inlet valve inlet port on the pressure source side, i.e. when ΔP<0.

Additionally, each inlet valve 6a-6d is embodied in such a manner that opening of the inlet valve in relation to pressure differences from both directions, in particular in relation to negative pressure differences ΔP, is guaranteed by deactivating the solenoid coil, e.g. by switching off or reducing the actuating current or the actuating voltage. For this purpose, the effect of the compression spring of the inlet valve is dimensioned accordingly. The inlet valves 6a-6d can be opened in relation to both a positive and a negative pressure difference over the inlet valve.

Overall, this means that it is possible to electrically specify (by the actuation current or the actuation voltage of the solenoid coil) whether the inlet valve is open or closed, regardless of the pressure difference over the inlet valve.

According to the example, each of the inlet valves can be closed or kept closed in relation to a positive pressure difference of a value up to 120 bar and opened in relation to a negative pressure difference of a value up to 100 bar.

A (system) pressure sensor 40 is connected to the brake line portion 60, by means of which the pressure generated by the pressure source 2 can be determined. In one embodiment, the pressure sensor 40 is the only pressure sensor of the brake system 1 or the brake control unit.

For feeding pressure medium into the pressure source 2, the pressure chamber 30 of the pressure source 2 is connected to the pressure medium reservoir 3 by way of a check valve 14, opening in the direction of the pressure chamber 30, and a hydraulic connection (line portions 61a, 61). According to the example, the line portion 61 is connected to a (second) port 71 of the pressure medium reservoir 3.

Furthermore, when the piston 31 is in a non-activated state, the pressure chamber 30 of the pressure source 2 is connected to the pressure medium reservoir 3 by way of a breather hole 80 and a hydraulic connection line (line portions 61b, 61), wherein the breather hole 80 is overrun/closed when the piston 31 is activated, the connection to the pressure medium reservoir 3 thus being separated. According to the example, the piston 31 is provided with at least one bore through which, in the non-activated state of the piston 31, the hydraulic connection between pressure chamber 30 and line portion 61b is established and which, when the piston 31 is activated, overruns a seal so that the hydraulic connection between pressure chamber 30 and line portion 61b is separated.

According to the example, the line portions 61a and 61b open into the line portion 61. The at least one breather hole 80 and the check valve 14 are thus connected to the (second) port 71 of the pressure medium reservoir 3 by way of an at least partially common hydraulic connection (line portion 61).

In order to actuate the pressure source 2, the brake system 1 comprises redundant sensor elements for detecting a rotating speed or a rotation angle of the electric motor 32. According to the example, a first motor angle sensor 43 and a second motor angle sensor 42 are provided.

The brake system 1 advantageously comprises only the one hydraulic pressure source 2. The brake system 1 comprises neither a second electrically actuatable hydraulic pressure source nor a driver-activatable pressure source, e.g. a brake pedal-activatable master brake cylinder, for the implementation of a hydraulic, driver-activated fallback plane.

Advantageously, apart from the electrically activatable inlet and outlet valves 6a-6d, 7a-7d, the brake system 1 according to the example advantageously does not comprise any other electrically activatable valves.

The brake system 1 furthermore comprises a first electronic control and feedback-control unit (ECU) A and a second electronic control and feedback-control unit (ECU) B for actuating the electrically activatable components of the brake system 1.

The first electronic control and feedback-control unit A and the second electronic control and feedback-control unit B are advantageously electrically independent of one another in the sense that a failure of the first electronic control and feedback-control unit does not cause a failure of the second electronic control and feedback-control unit, and vice versa. For this purpose, the electronic control and feedback-control units A and B can be embodied as separate units, but they can also be embodied as independent subunits in the same electronic control and feedback-control unit.

The arrows A or B on the electrical or electrically activatable components such as valves 6a-6d, 7a-7d and sensors 40, 42, 43, 44 indicate the assignment to the electronic control and feedback-control unit A or B.

The electric motor 32 of the pressure source 2 is actuatable by the first and second electronic control and feedback-control units A, B, i.e. each of the electronic control and feedback-control units A, B is individually suitable for building up a brake pressure by the pressure source 2 for carrying out service braking. This means that the pressure source 2 and the electronic control and feedback-control units A, B are configured in such a manner that, in the event of failure of the first electronic control and feedback-control unit A, the pressure source 2 can be actuated by the second electronic control and feedback-control unit B in order to build up a brake pressure for activating the wheel brakes 5a-5d during service braking or regulating braking and that, in the event of a failure of the second electronic control and feedback-control unit B, the pressure source 2 can be actuated by the first electronic control and feedback-control unit A in order to build up a pressure for activating the wheel brakes 5a-5d during service braking or regulating braking.

According to the example, the electric motor is configured as a double-wound electric motor 32 having the first motor winding 34a and the second motor winding 34b. The electric motor 32 of the pressure source 2 is actuated by the first and second electronic control and feedback-control unit in the sense that the first motor winding 34a is actuated (preferably only) by the first electronic control and feedback-control unit A (marked by the arrow with A) and the second motor winding 34b is actuated (preferably only) by the second electronic control and feedback-control unit B (marked by the arrow with B), in particular supplied with electric power by the electronic control and feedback-control unit. For this purpose, the motor winding 34a is connected to the first control and feedback-control unit A, and the other motor winding 34b is connected to the second control and feedback-control unit B. In order to actuate the pressure source 2, each of the two control and feedback-control units A, B comprises a motor processor for processing the motor feedback-control functions, an output stage with transistors for providing the phase voltages at the electric motor 32 (e.g. B6 bridge), and a driver stage (gate drive unit) for actuating the transistors of the output stage.

In the event of a failure of one of the electronic control and feedback-control units A or B, the pressure source 2 is actuated by the other electronic control and feedback-control unit B or A, and a pressure is built up for activating the wheel brakes 5a-5d in the brake-by-wire operating mode for service braking. The pressure source 2 or the electric motor 34 is operated by one of the functional electronic control and feedback-control units B or A with at least part of its power for building up a pressure for activating the wheel brakes.

The electrically activatable inlet and outlet valves 6a-6d, 7a-7d and the sensors 40, 42, 43, 44 of the brake system 1 are each assigned to only one of the electronic control and feedback-control units. This means that each inlet or outlet valve 6a-6d, 7a-7d is actuated exclusively by the electronic control and feedback-control unit A or exclusively by the electronic control and feedback-control unit B. Complex, dual-activatable valves/valve coils are avoided as a result. More specifically, the signals of each sensor 40, 42, 43 or 44 are supplied exclusively to the electronic control and feedback-control unit A or exclusively to the electronic control and feedback-control unit B.

All electrically activatable valves, i.e., for example, the electrically activatable inlet and outlet valves 6a-6d, 7a-7d, are advantageously assigned to the same electronic control and feedback-control unit, for example, the electronic control and feedback-control unit A, and are actuated exclusively by the electronic control and feedback-control unit A.

The signals of the (first) motor angle sensor 43 are supplied to the second electronic control and feedback-control unit B and evaluated by the latter, whereas the signals of the (second) motor angle sensor 42 are supplied to the first electronic control and feedback-control unit A and evaluated by the latter.

The signals of the pressure sensor 40 are advantageously supplied to the same electronic control and feedback-control unit A, which also actuates the inlet and outlet valves 6a-6d, 7a-7d, i.e. the signals of the pressure sensor 40 are supplied, for example, to the first electronic control and feedback-control unit A and evaluated by the latter.

After a failure of one of the electronic control and feedback-control units A or B, the pressure source 2 can nevertheless be actuated by one of the motor windings 34a or 34b and one of the motor angle sensors 42 or 42 (or optionally the pressure sensor 40) and thus a suitable pressure can be built up, albeit possibly at a reduced level and/or with reduced dynamics. All wheel brakes 5a-5d can be impinged with this (central) pressure. The (central) pressure can also be modulated by pushing the piston 31 back and forth.

Advantageously, the brake system 1 is supplied by a redundant on-board network with two independent voltage sources (a first electrical power supply and a second electrical power supply) in such a way that the two control and feedback-control units A and B are not supplied by the same electrical power supply. For example, control and feedback-control units A are supplied by the first electrical energy supply, and control and feedback-control units B are supplied by the second electrical energy supply.

According to the example, the brake system 1 comprises electric parking brakes 50a, 50b on the wheels of one of the axles, for example on the rear wheels RL, RR. The electric parking brakes 50a, 50b are actuated or activated by the electro-hydraulic brake control unit.

Advantageously, the wheel brakes of the rear axle are designed as combination brake calipers with a hydraulic wheel brake 5c, 5d and an integrated, electrically activatable parking brake (IPB).

According to the example, one of the electric parking brakes, e.g. parking brake 50a, is activated/actuated by the first electronic control and feedback-control unit A (this is indicated by the arrow with A), while the other of the electric parking brakes, e.g. parking brake 50b, is activated/actuated by the second electronic control and feedback-control unit B (this is indicated by the arrow with B). After a failure of one of the control and feedback-control units A or B, the vehicle can still be secured by at least one of the parking brakes, which is activated by the functional control and feedback-control unit B or A. This eliminates the need for a transmission parking lock.

In one embodiment, the brake system also comprises an activation unit for a vehicle driver (not shown in FIG. 1). The activation unit is connected to the brake control unit (HECU) on the signal side to transmit a signal of the driver's intention, but there is no mechanical-hydraulic connection from the activation unit to the brake control unit or the wheel brakes 5a-5d.

In the event of a failure of the second electronic control and feedback-control unit B, the hydraulic braking function of the brake system by the pressure source 2, including the wheel pressure feedback-control by the inlet and outlet valves 6a-6d, 7a-7d, can be performed by the first electronic control and feedback-control unit A, the only limitation being, potentially, that the output of the pressure source 2 is reduced.

Since the outlet valves 7a-7d are closed when non-energized and the inlet valves 6a-6d are open when non-energized, all wheels can be hydraulically braked in the event of a failure of the first electronic control and feedback-control unit A. For this purpose, the second electronic control and feedback-control unit B feedback-controls the volume of delivered pressure medium, if no pressure signal is made available to the former. A common pressure modulation on all wheel brakes 5a-5d remains possible.

If the brakes are not applied, the wheel brakes 5a-5d should be under atmospheric pressure. For this purpose, the pressure source 2 is actuated and returned to its non-activated state in such a way that a hydraulic connection to the pressure medium reservoir 3 is established by way of the breather hole, which is under atmospheric pressure.

The brake system according to the invention offers the following advantages:
An electrically activatable sequence valve between the pressure source 2 and the inlet valves 6a-6d, or an electrically activatable 2-way valve which is open when non-energized, optionally including a parallel check valve assembly, coil and valve driver output stage, can be dispensed with.
The brake system has low throttle losses in the main flow path between the pressure source 2 and the wheel brakes 5a-5d.
Wheel brake pressure feedback-control can be carried out in a known manner by a single electronic control and feedback-control unit A.
Due to the small number of valves and other components, this results in greater degrees of freedom in the design of the valve grid as well as the possibility of reducing the size of the valve block.
Opening an inlet valve 6a-6d in relation to a (higher) wheel brake pressure can be supported by the pressure source 2 even in the event of failure of one of the electronic control and feedback-control units A, B or one of the on-board networks. The compression spring of the inlet valve 6a-6d can therefore be dimensioned so as to be lower in force in comparison to known, non-redundant multiplex architectures.
In the brake system, the axle-specific or wheel-specific pressure requirements can be pressure-feedback-controlled by the pressure source 2 and can also be represented conveniently in the pressure reduction direction (e.g. “blending”).
The brake system offers the potential of 4-channel wheel pressure feedback-control.

When using the outlet valves 7a-7d for wheel-specific pressure feedback-control, pressure medium volume is consumed in the sense that pressure medium is discharged from the pressure chamber 30 by way of the wheel brakes 5a-5d into the pressure medium reservoir 3. Accordingly, the pressure medium volume must be fed into the pressure chamber 30 of the pressure source 2 at the latest when the pressure medium volume in the pressure chamber 30 reaches a lower limit value.

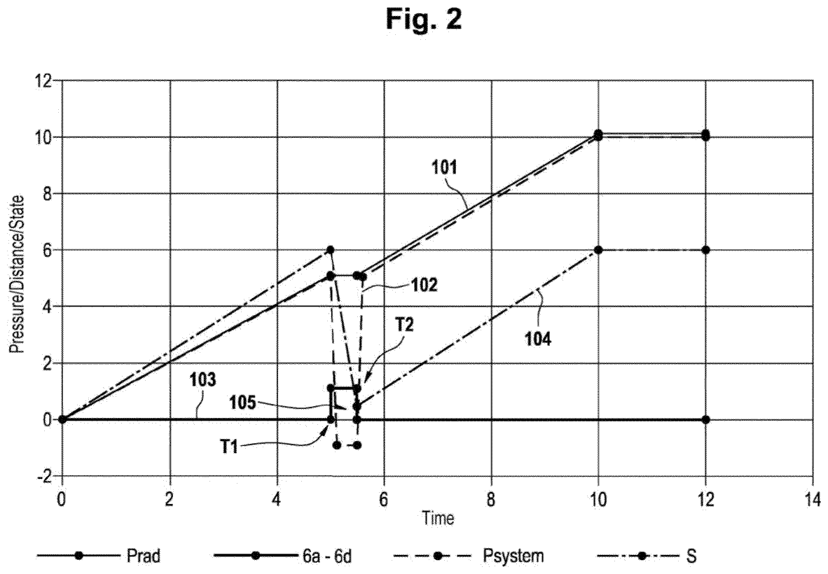

An exemplary method for feeding pressure medium into the pressure source 2 is schematically illustrated in FIG. 2. Shown as a function of time are: a wheel brake pressure Prad at the wheel brakes (line 101); a system brake pressure Psystem (line 102); the switching status of the inlet valves 6a-6d (line 103), where zero (0) means the inlet valves are open, one (1) means the inlet valves are closed; and a travel path S of the pressure source 2 (line 104), e.g. the travel path of the piston 31 of the pressure source. If a looming depletion of the pressure medium volume in the pressure source 2 is detected during an advancement/pressure build-up of the pressure source, the inlet valves 6a-6d are closed at time T1. The piston 31 is then moved (back) in the release direction (in the direction of the non-activated state of the pressure source 2 or the piston 31). In the process, pressure medium flows from the pressure medium reservoir 3 by way of the feeder valve 14 into the pressure chamber 30, so that refilling/feeding 105 of pressure medium from the pressure medium reservoir occurs. The wheel brake pressure Prad in the wheel brakes remains constant here. At time T2, the piston 31 is moved forward again in order to achieve an approximation of the system brake pressure Psystem to the wheel brake pressure Prad, and the inlet valves 6a-6d are opened. The pressure feedback-control on the wheel brakes can continue.

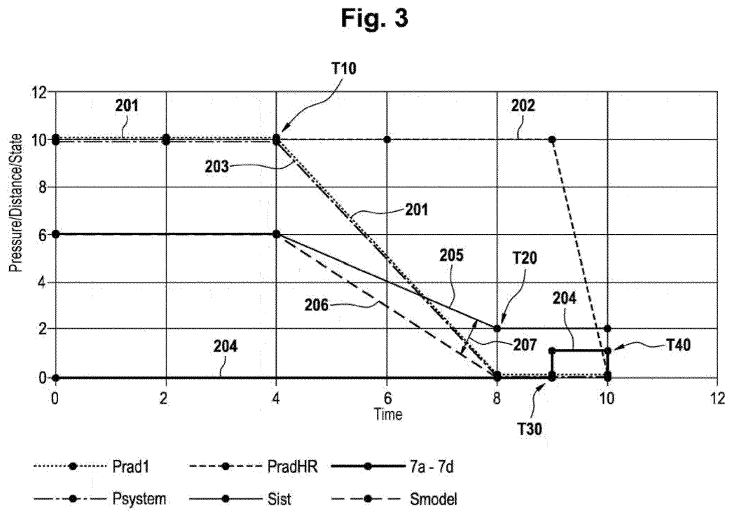

In order to prevent a failure of a compression spring of an inlet valve 6a-6d leading to overbraking by not releasing one or a plurality of wheel brakes 5a-5d, an identification method may be carried out. FIG. 3 illustrates a method according to the example for identifying an unintentionally closed inlet valve. Illustrated as a function of time are: the wheel brake pressure Prad1 at the front axle and the left rear wheel (line 201), the wheel brake pressure PradHR at the right rear wheel (line 202), the system brake pressure Psystem (line 203) and the switching status of the outlet valves 7a-7d (line 204), where zero (0) means the outlet valves are closed, one (1) means the outlet valves are open. Furthermore illustrated in FIG. 3 are the current travel path Sist of the pressure source 2 (line 205), which is a measure for the actually displaced pressure medium volume of the pressure chamber 30, and the model travel path Smodel of the pressure source 2 (line 206) determined on the basis of a volume model.

Until time T10, the pressure source 2 is activated by way of the piston 31, and the desired wheel brake pressures at the wheel brakes 5a-5d of the front and rear axle are kept constant. The inlet valves 6a-6d are open and the outlet valves 7a-7d are closed. A brake pressure reduction is then to be carried out on the wheel brakes 5a-5d by the pressure source 2. For this purpose, at time T10 the piston 31 of the pressure source 2 is retracted (the travel is reduced) in order to extract pressure medium from the wheel brakes. Accordingly, the system brake pressure Psystem and the wheel brake pressure Prad1 on the front axle and the left rear wheel drop, while the wheel brake pressure PradHR on the right rear wheel remains constant due to the incorrectly closed inlet valve 6d. The model travel distance Smodel, calculated on the basis of the volume model using the measured system brake pressure Psystem and assuming four open inlet valves 6a-6d, differs more and more from the actual travel distance Sist determined on the basis of the sensor 42, 43 over time, as less volume (thus travel) is suctioned from the three wheel brakes 5a-5c due to the incorrectly closed inlet valve 6d. An unintentionally closed inlet valve is therefore identified by a plausibility check 207, or a comparison of the measured system brake pressure Psystem (corresponds by way of the volume model with Smodel) and the pressure medium volume shifted by the pressure source 2 (corresponds with Sist). At time T20, the system brake pressure Psystem is zero, but the wheel brake 5d of the right rear wheel still has the wheel brake pressure PradHR. Due to the error identified on the basis of the plausibility check, the outlet valves 7a-7d are opened at time T30 in order to ensure a pressure reduction on all wheel brakes 5a-5d. The wheel brake pressure PradHR is reduced by way of the open outlet valve 7d until time T44, and the outlet valves 7a-7d are closed again.

In order to identify an unintentionally closed inlet valve, as can be caused by a failure of a compression spring, the pressure medium volume flowing back from the wheel brakes 5a-5d is balanced when releasing the pressure source 2. In the event of a variation between the actual pressure medium volume and that determined on the basis of a volume model, or in the event of a suspicion of one or a plurality of unintentionally closed inlet valves, a pressure reduction is triggered by way of the outlet valves 7a-7d.

Other methods such as cyclic self-tests with identification of the waste flow of the inlet valve solenoid coils in the case of inductance changes (e.g. “fluxing”) can be used alternatively or additionally.

The fault response to a suspected non-opening inlet valve is the respective pressure reduction by way of the outlet valves 7a-7d.

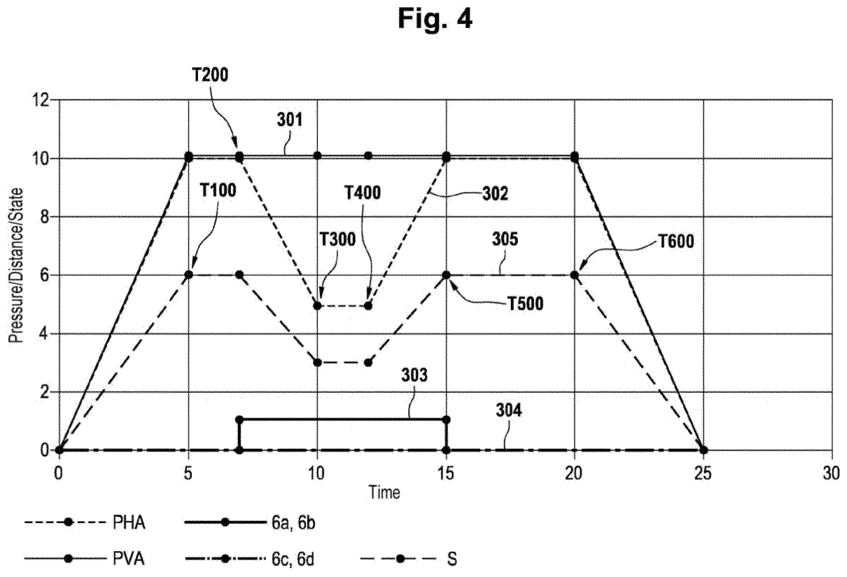

FIG. 4 shows a method according to the example for the axle-specific pressure feedback-control. Illustrated as a function of time are: the wheel brake pressure PVA at the front axle wheel brakes 5a, 5b (line 301); the wheel brake pressure PHA at the rear axle wheel brakes 5c, 5d (line 302); the switching status of the inlet valves 6a, 6b of the front axle wheel brakes 5a, 5b (line 303) and the inlet valves 6c, 6d of the rear axle wheel brakes 5c, 5d (line 304), where zero (0) means the inlet valves are open, one (1) means the inlet valves are closed; and a travel path S of the pressure source 2 (line 305), e.g. the travel path of the piston 31 of the pressure source. From time zero, the piston 31 of the pressure source 2 is advanced with the inlet valves 6a-6d open, and the wheel brake pressures at the front axle and rear axle wheel brakes 5a-5d increase. At time T100, piston 31 is stopped and the wheel brake pressures at the front axle and rear axle wheel brakes 5a-5d remain constant. Now an axle-specific pressure reduction is to be carried out on the rear axle wheel brakes 5c, 5d, whereby the pressure in the front axle wheel brakes 5a, 5d is to be maintained at the higher pressure level. Therefore, at time T200, (only) the inlet valves 6a, 6b of the front axle wheel brakes 5a, 5b are closed and the piston 31 of the pressure source 2 is retracted. The wheel brake pressure PVA at the front axle wheel brakes 5a, 5b remains constant due to the closed inlet valves 6a, 6b; the wheel brake pressure PHA at the rear axle wheel brakes 5c, 5d decreases, because pressure fluid volume from these wheel brakes 5c, 5d is suctioned into the pressure chamber 30 of the pressure source 2. At time T300, the piston 31 is stopped and the wheel brake pressure PHA at the rear axle wheel brakes 5c, 5d remains constant. From time T400 onward, the wheel brake pressure PHA at the rear axle wheel brakes 5c, 5d is raised back to the pressure level of the front axle wheel brakes 5a, 5b by advancing the piston 31 of the pressure source 2. At time T500, the rear axle wheel brakes 5c, 5d have reached the wheel brake pressure PVA of the front axle wheel brakes 5a, 5b. The piston 31 of the pressure source 2 is stopped and the inlet valves 6a, 6b of the front axle wheel brakes 5a, 5d are reopened. The wheel brake pressure PVA of the front axle wheel brakes 5a, 5b, the wheel brake pressure PHA of the rear axle wheel brakes 5c, 5d, and the system brake pressure are again at the same pressure level. From time T600 onward, the pressure feedback-control is stopped, the piston 31 of the pressure source 2 is returned to its release position, and the wheel brake pressures PVA and PHA return to zero (atmospheric pressure).

For an axle- or wheel-specific pressure feedback-control on the wheel brakes 5a-5d, a convenient pressure reduction without switching the outlet valves 7a-7d may be carried out. The higher wheel pressure value (first target pressure value) is set using the pressure source 2 on the wheel brakes 5a-5d. The inlet valves of the high-pressure axle (axle with the higher wheel pressure value/first target pressure value, in the example the front axle wheel brakes), or of the high-pressure wheel, are then closed. On the low-pressure axle (in the example the rear axle wheel brakes) or the low-pressure wheel, pressure modulation is then carried out by the pressure source 2 (build up or reduce pressure), e.g. a brake pressure reduction (to a lower second target pressure value) by retracting the piston 31 of the pressure source.

1-13. (canceled)

14. A brake system for a motor vehicle, comprising:
a plurality of hydraulic output ports, each output port allowing connection of a hydraulically activatable wheel brake;
an electrically actuatable hydraulic pressure source including a cylinder-piston assembly having a pressure chamber and a piston, wherein the piston is configured to be actuated forward and backward with an electric motor;
a first electronic control and feedback-control unit;
a second electronic control and feedback-control unit;
a pressure medium reservoir which is under atmospheric pressure;
a plurality of electrically activatable inlet valves, each inlet valve hydraulically connected between the pressure source and one of the output ports, each inlet valve being open when non-energized and having a compression spring and a solenoid coil; and
a plurality of electrically activatable outlet valves, each outlet valve hydraulically connected between the pressure medium reservoir and one of the outlet ports, each outlet valve being closed when non-energized;
wherein the electric motor of the pressure source is actuatable by either of the first and second electronic control and feedback-control units; and
wherein each of the inlet valves is a 2/2-way valve and in such a manner that the inlet valve may be closed in response to pressure differences from both directions by actuating the solenoid coil, and may be opened in response to pressure differences from both directions by switching off or reducing the actuation of the solenoid coil.

15. The brake system as set forth in claim 14, wherein each of the inlet valves may be closed and opened in response to a pressure difference from both directions of a value up to 120 bar.

16. The brake system as set forth in claim 14, wherein no check valve is connected in parallel with any of the inlet valves, and none of the inlet valves includes an integrated check valve.

17. The brake system as set forth in claim 14, wherein the compression spring of each inlet valve is dimensioned in such a manner that the inlet valve may be opened in relation to a negative pressure difference over the inlet valve by switching off the actuation of the solenoid coil.

18. The brake system as set forth in claim 14, wherein no valve is disposed between the pressure chamber of the pressure source and each of the inlet valves.

19. The brake system as set forth in claim 14, wherein the inlet and outlet valves are the only electrically activatable valves.

20. The brake system as set forth in claim 14, wherein each electrically actuatable valve is activated by the first electronic control and feedback-control unit.

21. The brake system as set forth in claim 14, further comprising only one pressure sensor, wherein the pressure generated by the pressure source is determined by the pressure sensor, and the signals of the pressure sensor are supplied to and evaluated by the first electronic control and feedback-control unit.

22. The brake system as set forth in claim 14, further comprising a first sensor for detecting a rotation angle or a rotating speed of the electric motor and an independent second sensor for detecting a rotation angle or a rotating speed of the electric motor, wherein the signals of the first sensor are supplied to and evaluated by the second electronic control and feedback-control unit and the signals of the second sensor are supplied to and evaluated by the first electronic control and feedback-control unit.

23. The brake system as set forth in claim 14, wherein the motor vehicle includes a rear axle with a first electrically activatable parking brake and a second electrically activatable parking brake coupled to the rear axle, and wherein the first electrically activatable parking brake is activated by the first electronic control and feedback-control unit, and the second electrically activatable parking brake is activated by the second electronic control and feedback-control unit.

24. A method for operating a brake system of a motor vehicle, the brake system including a plurality of hydraulic output ports, each output port allowing connection of a hydraulically activatable wheel brake, an electrically actuatable hydraulic pressure source including a cylinder-piston assembly having a pressure chamber and a piston, wherein the piston is configured to be actuated forward and backward with an electric motor, a first electronic control and feedback-control unit, a second electronic control and feedback-control unit, a pressure medium reservoir which is under atmospheric pressure, a plurality of electrically activatable inlet valves, each inlet valve hydraulically connected between the pressure source and one of the output ports, each inlet valve being open when non-energized and having a compression spring and a solenoid coil, and a plurality of electrically activatable outlet valves, each outlet valve hydraulically connected between the pressure medium reservoir and one of the outlet ports, each outlet valve being closed when non-energized, wherein the electric motor of the pressure source is actuatable by either of the first and second electronic control and feedback-control units, and wherein each of the inlet valves is a 2/2-way valve and in such a manner that the inlet valve may be closed in response to pressure differences from both directions by actuating the solenoid coil, and may be opened in response to pressure differences from both directions by switching off or reducing the actuation of the solenoid coil, said method comprising:
maintaining the feeding pressure medium into the pressure chamber of the pressure source by closing the inlet valves; and
retracting the piston of the pressure source with the electric motor.

25. The method as set forth in claim 24, further comprising:
advancing the piston of the pressure source with the electric motor when the inlet valves are closed until the pressure of the pressure source approximately equals the pressures of the wheel brakes; and
opening the inlet valves in response to the pressure of the pressure source approximately equals the pressures of the wheel brakes.

26. The method as set forth in claim 24, further comprising:
comparing a model pressure medium volume determined by way of a measured pressure of the pressure source and a pressure medium volume displaced by the pressure source; and
opening the outlet valves in the event of a variation of the model pressure medium volume and the pressure medium volume displaced by the pressure source.
